(19) United States
(12) Patent Application Publication
(10) Pub. No.: US 2007/0244229 A1
(43) Pub. Date: Oct. 18, 2007

(54) Flameproof Thermoplastic Resin Composition

(76) Inventors: Sang Hyun Hong, Gyeonggi-do (KR); Sung Hee Ahn, Seoul (KR); Jae Ho Yang, Gyeonggi-do (KR); Su Hak Bae, Seoul (KR); Young Sik Ryu, Gyeonggi-do (KR)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/570,729

(22) PCT Filed: Jun. 17, 2004
(86) PCT No.: PCT/KR04/01454

§ 371 Date: May 11, 2007

(51) Int. Cl. C08L 51/04; C08K 5/521

(52) U.S. Cl. 524/107

(57) ABSTRACT

The flameproof resin composition according to the present invention comprises (A) 100 parts by weight of a rubber modified polystyrene resin containing (a₁) 20 to 100% by weight of graft copolymer prepared by graft-polymerizing 5 to 65% by weight of a rubber polymer, 30 to 95% by weight of an aromatic vinyl monomer, 0 to 20% by weight of a monomer copolymerizable with said aromatic vinyl monomer and 0 to 15% by weight of a monomer for providing good processability and heat resistance; and (a₂) 0 to 80% by weight of copolymer prepared by polymerizing 60 to 90% by weight of an aromatic vinyl monomer, 10 to 40% by weight of a monomer copolymerizable with said aromatic vinyl monomer and 0 to 30% by weight of a monomer for providing good processability and heat resistance; and (B) 15 to 40 parts by weight of an oxaphospholane compound.

### FIELD OF THE INVENTION

The present invention relates to a styrenic resin composition having good flame retardancy and environment-friendly effect. More particularly, the present invention relates to a styrenic thermoplastic resin composition with good flame retardancy as well as an environment-friendly effect by employing an oxaphospholane compound as a flame retardant to a rubber modified styrenic resin.

### BACKGROUND OF THE INVENTION

A rubber modified styrenic resin has a good processability, a high mechanical properties, especially impact strength, and a good appearance. Therefore, the resin has been widely applied to electric or electronic goods and office supplies. However, the disadvantage could be observed when the rubber modified styrenic resin is applied to heat-emitting products, such as computers, facsimiles and the like, because the styrenic resin is extremely easy to catch a fire. Therefore, the methods for improving the flame-retardant property of the rubber-modified styrenic resin have been developed.

A widely known method for flame retardancy is that a halogen-containing compound is added to a rubber modified styrenic resin to give a good flame-retardant property. The examples of the halogen-containing compounds used in the method above are, for example, polybromodiphenyl ether, tetrabromobisphenol-A, epoxy compounds substituted by bromine, etc. An antimony-containing compound may added together to further increase the flame retardancy.

However, the methods for improving the flame-retardant property by applying a halogen- and antimony-containing compound have disadvantages that the halogen-containing compound cause the corrosion of the mold itself by the hydrogen halide gases released during the molding process and is fatally harmful due to the toxic gases liberated in case of fire. Especially, a polybromodiphenyl ether, mainly used for a halogen-containing flame retardant, tends to generate toxic gases such as dioxin or furan during combustion. So, a major concern in this field is to develop a flame retardant resin which is prepared without a halogen-containing compound.

It is a commonly known method to apply an aromatic phosphate ester compound as a halogen-free flame retardant to a styrenic resin. However, usage of only an aromatic phosphate ester does not impart sufficient flame retardancy of UL 94 V1. In order to solve the above problem, methods using aromatic phosphate ester to a blend of styrenic resin and polyphenylene ether resin or a blend of styrenic resin and a polycarbonate resin have been proposed.

U.S. Pat. No. 3,639,506 discloses resin composition using mono aromatic phosphate ester such as triphenylphosphate to a blend of high impact polystyrene resin and polyphenylene ether resin.

U.S. Pat. No. 5,061,745 discloses a thermoplastic resin composition using a mono phosphate ester to a blend of an ABS graft copolymer and a polycarbonate resin. In addition, U.S. Pat. No. 5,204,394 discloses a resin composition using an oligomeric phosphate ester as a flame retardant to a blend of an ABS resin and a polycarbonate resin.

Accordingly, the present inventors have developed a flameproof thermoplastic resin composition without using a polyphenylene ether resin or a polycarbonate resin.

### OBJECTS OF THE INVENTION

An object of the present invention is to provide a thermoplastic resin composition having stability for the fire.

Another object of the present invention is to provide an environment friendly thermoplastic resin composition which does not contain a halogen-containing compound which causes the environmental pollution during preparation or combustion of the resin.

A further object of the present invention is to provide a thermoplastic resin composition with good flame retardancy without using a polyphenylene resin or a polycarbonate resin.

Other objects and advantages of this invention will be apparent from the ensuing disclosure and appended claims.

### SUMMARY OF THE INVENTION

A flameproof resin composition according to the present invention comprises (A) 100 parts by weight of a rubber modified polystyrene resin containing (a₁) 20 to 100% by weight of graft copolymer prepared by graft-polymerizing 5 to 65% by weight of a rubber polymer, 30 to 95% by weight of an aromatic vinyl monomer, 0 to 20% by weight of a monomer copolymerizable with said aromatic vinyl monomer and 0 to 15% by weight of a monomer for providing good processability and heat resistance; and (a₂) 0 to 80% by weight of copolymer prepared by polymerizing 60 to 90% by weight of an aromatic vinyl monomer, 10 to 40% by weight of a monomer copolymerizable with said aromatic vinyl monomer and 0 to 30% by weight of a monomer for providing good processability and heat resistance; and (B) 15 to 40 parts by weight of an oxaphospholane compound.

### DETAILED DESCRIPTION OF THE INVENTION

(A) Rubber Modified Polystyrene Resin

The rubber modified polystyrene resin according to the present invention is a polymer wherein rubber phase polymers are dispersed in the form of particles in a matrix obtained by polymerizing an aromatic vinyl monomer and a vinyl group-containing monomer. The rubber modified polystyrene resin can be prepared by polymerizing aromatic vinyl monomer and optionally a monomer copolymerizable with said aromatic vinyl monomer with a rubber phase polymer.

Such rubber modified polystyrene resin is prepared by a known method such as emulsion polymerization, suspension polymerization or bulk polymerization, and is conventionally produced by an extrusion with a styrene-containing graft copolymer resin and a styrene-containing copolymer resin. In a bulk polymerization, both a styrene-containing graft copolymer resin and a styrene-containing copolymer resin are prepared together in one process. In other polymerizations, a styrene-containing graft copolymer resin and a styrene-containing copolymer resin may be prepared separately. In either case, the contents of rubber in a final rubber modified polystyrene resin to the total weight of the base resin are preferably in 5 to 30% by weight.

In the rubber modified polystyrene resin of the present invention, a graft copolymer resin can be used alone or in combination with a copolymer resin in consideration of compatibility thereof.

(a₁) Graft Copolymer

Examples of a rubber polymer for preparing the graft copolymer are diene rubbers such as polybutadiene, poly(styrene-butadiene), poly(acrylonitrile-butadiene), etc; saturated rubbers in which hydrogen is added to said diene-containing rubber; isoprene rubber; acryl rubbers such as polybutyl acrylic acid; and terpolymer of ethylene-propylene-diene (EPDM). It is preferable to use a diene-containing rubber, more preferably a butadiene-containing rubber. The content of rubber in the graft copolymer is preferably in the range of 5 to 65% by weight based on the total weight of the graft copolymer.

Examples of an aromatic vinyl monomer for preparing the graft copolymer are styrene, α-methyl styrene, p-methyl styrene, etc. In the above examples, styrene is the most preferable.

In the graft copolymer of the present invention, at least one monomer copolymerizable with said aromatic vinyl monomer may be introduced. It is preferred that the copolymerizable monomer is a cyanide vinyl-containing compound such as acrylonitrile or an unsaturated nitrile-containing compound such as methacrylonitrile.

The graft copolymer of the present invention is prepared by graft copolymerizing 5˜65% by weight of the rubber, 30˜95% by weight of the aromatic vinyl monomer and 0˜20% by weight of the copolymerizable monomer.

In addition, in order to give good characteristics of processability and heat resistance, the monomers such as acrylic acid, methacrylic acid, maleic anhydride and N-substituted maleimide can be added in the graft polymerization. The amounts of the monomers are in the range of 0 to 15% by weight based on the total weight of the graft copolymer

To acquire good impact strength and surface appearance when said styrene-containing graft copolymer is prepared, the average size of rubber particles is preferably in the range of from 0.1 to 4 μm.

(a₂) Copolymer

The copolymer of the present invention is prepared by copolymerizing an aromatic vinyl monomer and a copolymerizable monomer, depending on the ratio and compatibility between monomers except rubber in the graft copolymer.

Examples of the aromatic vinyl monomer are styrene, α-methylstyrene, p-methylstyrene, etc. Styrene is the most preferable. The aromatic vinyl monomer in the total copolymer is contained in the amount of 60 to 90% by weight.

In the copolymer of the present invention, at least one monomer copolymerizable with said aromatic vinyl monomer may be introduced. Examples of the copolymerizable monomer are cyanide vinyl-containing compounds such as acrylonitrile and unsaturated nitrile-containing compounds such as methacrylonitrile. It is preferable that 10 to 40% by weight of the copolymerizable monomer to the total copolymer is employed.

In addition, 0 to 30% by weight of other monomers such as acrylic acid, methacrylic acid, maleic anhydride and N-substituted maleimide may be added and copolymerized thereto in order to give good characteristics of processability and heat resistance.

Examples of the rubber modified polystyrene resin are acrylonitrile-butadiene-styrene (ABS) copolymer resin, acrylonitrile-ethylenepropylene rubber-styrene (AES) copolymer resin, acrylonitrile-acryl rubber-styrene (AAS) copolymer resin, high impact polystyrene resin (HIPS), and the like.

In this invention, the rubber modified polystyrene resin (A) comprises 20˜100% by weight of the graft copolymer (a₁) and 0˜80% by weight of the copolymer (a₂).

(B) Oxaphospholane Compound

The oxaphospholane compound of the present invention is represented by the following chemical formula (I):

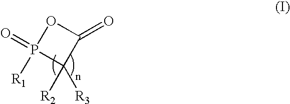

wherein R₁ is hydrogen, C₁₋₄ alkyl or C₆₋₁₀ aryl; R₂ and R₃ are independently of each other hydrogen or C₁₋₄ alkyl; and n is 1-3.

The preferable examples of the oxaphospholane compound are 2-methyl-2,5-dioxo-1-oxa-2-phosphorane and 2-phenyl-2,5-dioxo-1-oxa-2-phosphorane. The oxaphospholane compounds are used in single or in combination.

In the present invention, the oxaphospholane compound can be used in the amount of from 15 to 40 parts by weight, preferably 20 to 35 parts by weight per 100 parts by weight of the rubber modified polystyrene resin. If the amount of the oxaphospholane compound is less than 15 parts by weight, the resin composition cannot obtain sufficient flame retardancy, and if the amount of the oxaphospholane compound is more than 40 parts by weight, the compatibility between base resin and the oxaphospholane compound is deteriorated.

Other additives may be used in the thermoplastic resin composition of the present invention. The additives include an anti-dripping agent, a heat stabilizer, an oxidation inhibitor, a compatibilizer, a light stabilizer, an organic or inorganic pigment and/or dye, an inorganic filler and so forth. The additives are employed in an amount of 0˜30 parts by weight as per 100 parts by weight of the base resin.

The invention may be better understood by reference to the following examples which are intended for the purpose of illustration and are not to be construed as in any way limiting the scope of the present invention, which is defined in the claims appended hereto.

### EXAMPLES

The components to prepare the thermoplastic resin compositions in Examples 1˜3 and Comparative Examples 1˜3 are as follows:

(A) Rubber Modified Polystyrene Resin

(a₁) Graft Copolymer Resin

(a₁₁) Styrene-Acrylonitrile Containing Graft Copolymer Resin

50 parts of butadiene rubber latex powder, 36 parts of styrene, 14 parts of acrylonitrile, and 150 parts of deionized water were mixed. To the mixture, 1.0 part of potassium oleate, 0.4 parts of cumenhydroperoxide, 0.2 parts of mercaptan-containing chain transfer agent, 0.4 parts of glucose, 0.01 parts of ferrous sulfate hydrate, and 0.3 parts of sodium pyrophosphate were added. The blend was kept at 75° C. for 5 hours to obtain g-ABS latex. To the g-ABS latex, 0.4 parts of sulfuric acid was added, coagulated and dried to obtain rubber modified polystyrene resin (g-ABS) in a powder form.

(a₁₂) High Impact Polystyrene (HIPS)

High Impact Polystyrene (product name:HR-1380) having 7% by weight of butadiene rubber content, 1.5 μm of average rubber particle size, produced by Cheil Industries Inc. of Korea was used.

(a₂) Copolymer Resin

75 parts of styrene, 25 parts of acrylonitrile, and 120 parts of deionized water were mixed. To the mixture, 0.2 parts of azobisisobutylonitrile (AIBN), 0.4 parts of tricalcium phosphate and 0.2 parts of mercaptan-containing chain transfer agent were added. The resultant solution was heated to 80° C. for 90 minutes and kept for 180 minutes. The resultant was washed, dehydrated and dried to obtain styrene-acrylonitrile copolymer resin (SAN) in powder form.

(B) Oxaphospholane Compound

2-methyl-2,5-dioxo-1-oxa-2-phosphorane with a melting point of 102˜104° C. was used.

(B′) Aromatic Phosphate Ester Compound

Triphenylphosphate (TPP) with a melting point of 48° C. was used.

(C) Fluorinated Polyolefin Resin

Teflon (registered trademark) 7AJ produced by Dupont company was used as an anti-dripping agent.

### Examples 1˜3

The components as shown in Table 1 were mixed and the mixture was extruded at 180˜250° C. with a conventional twin screw extruder in pellets. The resin pellets were dried at 80° C. for 3 hours, and molded into test specimens using a 6 oz injection molding machine at 180˜280° C. and mold temperature of 40˜80° C. The flame retardancy of the test specimens was measured in accordance with UL94VB with a thickness of ⅛″ and 1/12″ respectively.

### Comparative Examples 1˜3

Comparative Example 1 was conducted in the same manner as in Example 1 except that the oxaphospholane compound was not used. Comparative Examples 2-3 were conducted in the same manner as in Examples 2-3 respectively except that the aromatic phosphate ester compound was used as a flame retardant instead of the oxaphospholane compound. The test results are presented in Table 1.

TABLE 1

| | | Examples | | | Comp. Examples | | |
|---|---|---|---|---|---|---|---|
| | | 1 | 2 | 3 | 1 | 2 | 3 |
| (A) Rubber Modified | (a₁₁) | 30 | 30 | — | 30 | 30 | — |
| Styrene Comprising | (a₁₂) | — | — | 100 | — | — | 100 |
| Resin | (a₂) | 70 | 70 | — | 70 | 70 | — |

| | | | | | | |
|---|---|---|---|---|---|---|
| (B) oxaphospholane | 20 | 30 | 30 | — | — | — |
| (B′) TPP | — | — | — | — | 30 | 30 |
| (C) Teflon | — | — | 0.2 | — | — | 0.2 |
| UL94 flame retardancy | V-1 | V-0 | V-0 | Fail | Fail | Fail |
| ( 1/12″) | | | | | | |
| UL94 flame retardancy | V-0 | V-0 | V-0 | Fail | V-2 | Fail |
| (⅛″) | | | | | | |

As shown above, the resin compositions employing oxaphospholane compound as a flame retardant show good UL94-flame retardancy. However, the resin compositions of Comparative Example 1 which does not use any flame retardant and Comparative Examples 2-3 which employ aromatic phosphate ester compound instead of oxaphospholane compound show poor flame retardancy.

The present invention can be easily carried out by an ordinary skilled person in the art. Many modifications and changes may be deemed to be with the scope of the present invention as defined in the following claims.

What is claimed is:

1. A flameproof thermoplastic resin composition comprising:
(A) 100 parts by weight of a rubber modified polystyrene resin containing (a₁) 20 to 100% by weight of graft copolymer prepared by graft-polymerizing 5 to 65% by weight of a rubber polymer, 30 to 95% by weight of an aromatic vinyl monomer, 0 to 20% by weight of a monomer copolymerizable with said aromatic vinyl monomer and 0 to 15% by weight of a monomer for providing good processability and heat resistance; and (a₂) 0 to 80% by weight of copolymer prepared by polymerizing 60 to 90% by weight of an aromatic vinyl monomer, 10 to 40% by weight of a monomer copolymerizable with said aromatic vinyl monomer and 0 to 30% by weight of a monomer for providing good processability and heat resistance; and
(B) 15 to 40 parts by weight of an oxaphospholane compound.

2. The flameproof thermoplastic resin composition as defined in claim 1, wherein said rubber polymer is selected from the group consisting of diene rubbers, saturated rubbers in which hydrogen is added to said diene-containing rubber, isoprene rubbers, acryl rubbers; and a terpolymer of ethylene-propylene-diene (EPDM).

3. The flameproof thermoplastic resin composition as defined in claim 1, wherein said aromatic vinyl monomer is selected from the group consisting of styrene, α-methyl styrene, p-methyl styrene.

4. The flameproof thermoplastic resin composition as defined in claim 1, wherein said monomer copolymerizable with said aromatic vinyl monomer is selected from cyanide vinyl-containing compounds and unsaturated nitrile-containing compounds.

5. The flameproof thermoplastic resin composition as defined in claim 1, wherein said monomer for providing good processability and heat resistance is selected from the group consisting of acrylic acid, methacrylic acid, maleic anhydride and N-substituted maleimide.

6. The flameproof thermoplastic resin composition as defined in claim 1, wherein said rubber modified polystyrene resin (A) is selected from the group consisting of acrylonitrile-butadiene-styrene (ABS) copolymer resin, acrylonitrile-acryl rubber-styrene (AAS) copolymer resin, acrylonitrile-ethylenepropylene rubber-styrene (AES), high impact polystyrene resin (HIPS).

7. The flameproof thermoplastic resin composition as defined in claim 1, wherein said oxaphospholane compound (B) is represented by following formula (I): 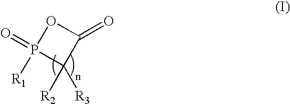
wherein R₁ is hydrogen, C₁₋₄ alkyl or C₆₋₁₀ aryl; R₂ and R₃ are independently of each other hydrogen or C₁₋₄ alkyl; and n is 1˜3.

8. The flameproof thermoplastic resin composition as defined in claim I, further comprising 0˜30 parts by weight of an additive selected from the group consisting of an anti-dripping agent, a heat stabilizer, an oxidation inhibitor, a compatibilizer, a light stabilizer, a pigment and/or a dye, an inorganic filler.
